(19) United States
(12) Patent Application Publication
(10) Pub. No.: US 2011/0231876 A1
(43) Pub. Date: Sep. 22, 2011

(54) APPARATUS AND METHOD FOR PROVIDING SERVICE ACCESS INFORMATION IN MOBILE BROADCASTING SYSTEM

(75) Inventors: Jun-Young Choe, Suwon-si (KR); Jeong-Sik Cho, Suwon-si (KR); Young-Jip Kim, Suwon-si (KR); Won-Suk Seo, Suwon-si (KR)

(73) Assignee: Samsung Electronics Co., Ltd.

(21) Appl. No.: 13/051,132

(22) Filed: Mar. 18, 2011

(30) Foreign Application Priority Data
Mar. 18, 2010 (KR) 10-2010-0024146

(51) Int. Cl. H04N 5/445

(52) U.S. Cl. 725/39

(57) ABSTRACT

An apparatus and a method for providing broadcasting service information in a mobile broadcasting system are provided. The method for determining broadcasting service information includes determining a mapping table which matches information of a Service Map Table (SMT) and an Electronic Service Guide (ESG); determining at least one component ID in an SMT provided from a serving base station; determining whether there is an ESG matching to the component ID of the SMT using the mapping table; and, when detecting the ESG matching to the component ID of the SMT, determining service information by combining the ESG that matches the SMT with the SMT.

### PRIORITY

The present application claims priority under 35 U.S.C. §119(a) to a Korean patent application filed in the Korean Intellectual Property Office on Mar. 18, 2010, and assigned Serial No. 10-2010-0024146, the entire disclosure of which is incorporated herein by reference.

### BACKGROUND OF THE INVENTION

1. Field of the Invention

The present invention relates generally to an apparatus and a method for providing service access information in a mobile broadcasting system. More particularly, the present invention relates to an apparatus and a method for matching program component information of a Service Map Table (SMT) and Electronic Service Guide (ESG) access information in the mobile broadcasting system.

2. Description of the Related Art

A mobile broadcasting system transmits data for the broadcasting service using a plurality of Radio Frequency (RF) channels. For example, according to an Advanced Television System Committee-Mobile/Handheld (ATSC-M/H) standard, the mobile broadcasting system transmits an ensemble over each RF channel. Herein, the ensemble includes data for at least one broadcasting service.

When the broadcasting service is provided using the ATSC-M/H standard, a mobile station must know an IDentifier (ID), such as a Transport Stream IDentification (TSID), of the RF channel being delivered the service for viewing, and an ensemble ID to access the service. That is, to access the broadcasting service, the mobile station needs to obtain component information of the RF channel and the ensemble, and information for the service access. Herein, the information for the service access includes an Internet Protocol (IP) address and a destination User Datagram Protocol (UDP) port number.

The mobile broadcasting system sends a Signaling Table (ST) and a Fast Information Channel (FIC) to the mobile station which is to receive the broadcasting service. Herein, the ST includes Service Map Table (SMT), Guide Access Table (GAT), Cell Information Table (CIT), Service Labeling Table (SLT), and Rating Region Table (RRT). The FIC includes the ensemble information of the RF channel.

The mobile broadcasting system transmits necessary information of the service based on a plurality of fragments according to a BroadCAST (BCAST) Electronic Service Guide (ESG) standard. Herein, the fragment includes service and program information, service charge information, and service access information.

As stated above, the mobile broadcasting system transmits to the mobile station the service access information and service play information using the SMT and the ESG. However, the mobile broadcasting system does not provide matching information of the SMT and the ESG. Therefore, the mobile station suffers from overhead in matching the SMT and the ESG by comparing SMT component information with IP address, audio and text information of Session Description Protocol (SDP).

### SUMMARY OF THE INVENTION

The present invention is designed to address at least the above-mentioned problems and/or disadvantages and to provide at least the advantages described below.

Accordingly, an aspect of the present invention to provide an apparatus and a method for providing service information in a mobile broadcasting system.

Another aspect of the present invention provides an apparatus and a method for matching Service Map Table (SMT) program component information and Electronic Service Guide (ESG) access fragment in a mobile broadcasting system.

Another aspect of the present invention provides an apparatus and a method for adding a component ID for ESG matching to the SMT in a mobile broadcasting system.

Another aspect of the present invention provides an apparatus and a method of a mobile station for matching ESG and SMT using a component ID of the SMT in a mobile broadcasting system.

Yet another aspect of the present invention provides an apparatus and a method of a base station for transmitting a mapping table including matching information of ESG and SMT to a mobile station in a mobile broadcasting system.

A further aspect of the present invention provides an apparatus and a method of a mobile station for matching ESG and SMT using a mapping table provided from a serving base station in a mobile broadcasting system.

In accordance with an aspect of the present invention, a method is provided for determining broadcasting service information in a mobile broadcasting system that includes determining whether a mapping table includes matching information of an SMT and an ESG; determining whether at least one component IDentifier (ID) in an SMT is provided from a serving base station; determining whether there is an ESG matching the component ID of the SMT using the mapping table; and when detecting whether the ESG matches the component ID of the SMT, determining service information by combining the ESG that matches the SMT with the SMT.

In accordance with another aspect of the present invention, an apparatus is provided for determining broadcasting service information in a mobile broadcasting system that includes a receiver for receiving a broadcasting signal; and a controller for, when detecting an ESG matching to a component ID of an SMT provided from a serving base station, based on a mapping table which includes matching information of the SMT and the ESG, determining service information by combining the ESG matching to the component ID the SMT with the SMT.

In accordance with yet another aspect of the present invention, a method is provided for transmitting broadcasting service information in a mobile broadcasting system that includes constituting an SMT and an ESG which include information relating to a broadcasting service; generating a mapping table which includes matching information of program components of the SMT and access fragments of the ESG, which include the same broadcasting service information; and transmitting the SMT, the ESG, and the mapping table over a service coverage area.

In accordance with still another aspect of the present invention, a method is provided for determining broadcasting service information in a mobile broadcasting system that includes determining at least one component ID in an SMT provided from a serving base station; determining an access information ID of an ESG matching to a program component of the SMT, using the component ID; and determining whether an ESG matches the component ID of the SMT, using the access information ID of the ESG matching the program component of the SMT. When detecting whether the ESG matching the component ID of the SMT, determining service information by combining the ESG that matches the SMT, with the SMT.

In accordance with a further aspect of the present invention, an apparatus is provided for determining broadcasting service information in a mobile broadcasting system that includes a receiver for receiving a broadcasting signal; and a controller for determining whether an ESG matches an SMT using at least one component ID of the SMT provided from a serving base station via the receiver. When detecting whether the ESG matches the component ID of the SMT, determining service information by combining the ESG matching to the component ID of the SMT, and the SMT.

In accordance with yet another aspect of the present invention, a method is provided for transmitting broadcasting service information in a mobile broadcasting system that includes generating an ESG which includes information relating to a broadcasting service; determining whether there is a program component of an SMT including a same broadcasting service information as an access fragment of the ESG; when detecting the program component of the SMT includes the same broadcasting service information as the access fragment of the ESG, generating an SMT by allocating a component ID of the program component using an access information ID of the access fragment of the ESG including the same broadcasting service information; and transmitting the ESG and the SMT over a service coverage area.

### BRIEF DESCRIPTION OF THE DRAWINGS

The above and other aspects, features, and advantages of certain embodiments of the present invention will be more apparent from the following description taken in conjunction with the accompanying drawings in which:

FIG. 1 is a block diagram of a mobile station of an embodiment of the present invention;

FIG. 2 is a flowchart illustrating a method for transmitting service access information in the mobile broadcasting system according to an embodiment of the present invention;

FIG. 3 is a flowchart illustrating the mobile station determining the service access information in the mobile broadcasting system according to an embodiment of the present invention;

FIG. 4 is a flowchart illustrating a method for transmitting the service access information in the mobile broadcasting system according to another embodiment of the present invention; and

FIG. 5 is a flowchart illustrating the mobile station determining the service access information in the mobile broadcasting system according to another embodiment of the present invention.

### DETAILED DESCRIPTION OF EMBODIMENTS OF THE PRESENT INVENTION

The following description with reference to the accompanying drawings is provided to assist in a comprehensive understanding of certain embodiments of the present invention, and includes various specific details to assist in that understanding. Throughout the drawings, similar reference numerals will be understood to refer to similar parts, components and structures. However, these specific details are to be regarded as merely exemplary. Accordingly, those of ordinary skill in the art will recognize that various changes and modifications of the embodiments described herein can be made without departing from the scope and spirit of the present invention. Additionally, descriptions of well-known functions and constructions are omitted for clarity and conciseness.

Certain embodiments of the present invention provide a technique for matching Service Map Table (SMT) program component information and Electronic Service Guide (ESG) access fragment in a mobile broadcasting system.

Herein, a mobile station is a terminal capable of receiving and playing a broadcast signal, and embraces every information communication device and multimedia device such as a mobile communication terminal, a digital broadcasting terminal, a Personal Digital Assistant (PDA), a smart phone, an International Mobile Telecommunication (IMT)-2000 terminal, a Wideband Code Division Multiple Access (WCDMA) terminal, and a Universal Mobile Telecommunication Service (UMTS) terminal.

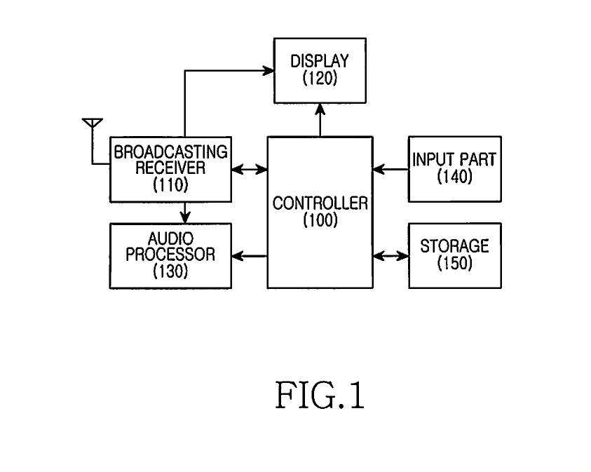

FIG. 1 is a block diagram of a mobile station in a mobile broadcasting system according to an embodiment of the present invention.

The mobile station of FIG. 1 includes a controller 100, a broadcasting receiver 110, a display 120, an audio processor 130, an input part 140, and storage 150.

The controller 100 controls operations of the mobile station. For example, the controller 100 controls the operations of the mobile station for receiving and playing programs and other content received via the broadcasting signal.

The controller 100 determines necessary information for service access by matching the ESG and the SMT provided from the broadcasting receiver 110. For instance, the controller 100 identifies the access fragment of the ESG that matches a component ID of the SMT based on a mapping table provided from a serving base station. The controller 100 may determine the access information ID of the ESG that matches the program component of the SMT based on the component ID of the SMT. Herein, the serving base station indicates a base station which provides the broadcasting service to the mobile station. The access information ID indicates information for identifying the access fragment of the ESG.

The broadcasting receiver 110 receives data over service channels selected by a user under the control of the controller 100. For example, the broadcasting receiver 110 includes a protocol processor and a decoder. The protocol processor decomposes the data of the service channels output from the broadcasting receiver 100 into video, audio, and broadcasting information data. The decoder decodes the video, audio and broadcasting information data provided via the protocol processor. The decoder can include an audio decoder for decoding the encoded audio data, and a video decoder for decoding the video data of the service channel. Herein, the broadcasting information data includes ESG data and SMT information.

The display 120 displays state information, input characters, movies, and photographs provided from the controller 100 or the broadcasting receiver 110. For example, the display 120 displays video data that is fed from the broadcasting receiver 110.

The audio processor 130 processes output of the audio signal fed from the controller 100 or the broadcasting receiver 110 through a speaker. The audio processor 130 processes an audio signal received through a microphone.

The input part 140 provides input data generated by the user's selection, to the controller 100.

The storage 150 can include a program storage for storing a program to control the operations of the mobile station, and a data storage for storing data generating in the program execution.

A method of the serving base station for sending the mapping table of the SMT and the ESG is further explained below.

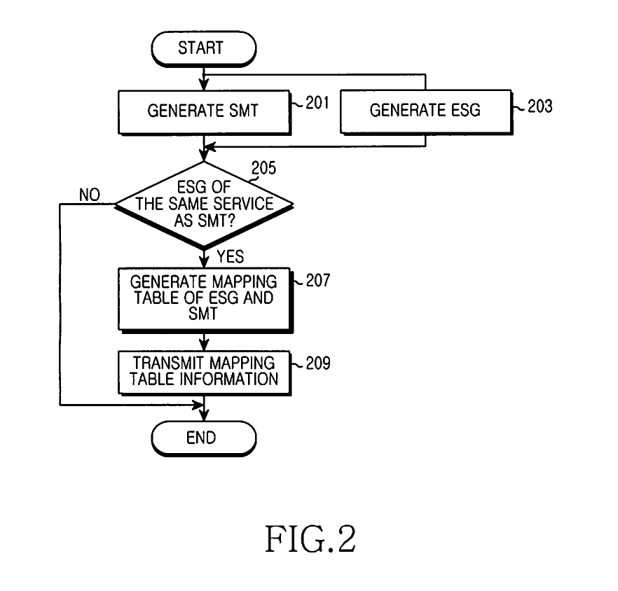

FIG. 2 is a flowchart illustrating a method for transmitting the service access information in the mobile broadcasting system according to an embodiment of the present invention.

In step 201, the serving base station generates the SMT. The serving base station generates the SMT to include component IDs for respective program components, for example as shown in Table 1.

TABLE 1

| Syntax | No. of Bits | Format |
|---|---|---|
| for (j=0; j<num_components; j++{ | | |
| Reserved | 1 | ‘1’ |
| essential_component_indicator | 1 | bsbif |
| component_destination_IP_address_flag | 1 | bsbif |
| port_num_count | 5 | uimsbf |
| component_destination_UDP_port_num | 16 | uimsbf |
| if(component_destination_IP_address_flag | | |
| component_destination_IP_address | 32 or 128 | uimsbf |
| component_ID | 4 | uimsbf |
| num_component_level_descriptors | 4 | uimsbf |
| . . . | . . . | . . . |
| . . . | | |
| } | | |

Herein, the serving base station constructs the SMT to include the component IDs for identifying the program components, as shown in Table 1. The component ID is used to identify the access fragment of the ESG matching to the program component of the SMT.

In step 203, the serving base station generates the ESG. For example, the serving base station generates the ESG including at least one access fragment.

After generating the SMT and the ESG, the serving base station determines whether the SMT and the ESG have the same service information in step 205. For example, the serving base station determines whether the SMT program component and the ESG access fragment include the same broadcasting service information.

When the SMT and ESG do not have the same service information, the serving base station ends the process.

When detecting the SMT and the ESG having the same service information, the serving base station generates the mapping table relating to the SMT and the ESG in step 207. For instance, the serving base station generates the mapping table including the mapping information of the SMT component ID and the ESG access information ID including the same broadcasting service information.

In step 209, the serving base station transmits the mapping table information to its service coverage area. The serving base station also transmits the generated SMT and ESG to the service coverage area.

The serving base station then ends this process.

In this embodiment, the serving base station concurrently generates the SMT and the ESG in parallel. Alternatively, the serving base station can generate the SMT and then the ESG. Alternatively, the serving base station may generate the ESG and then the SMT.

A method of the mobile station for matching the SMT and the ESG using the mapping table provided from the serving base station is described below.

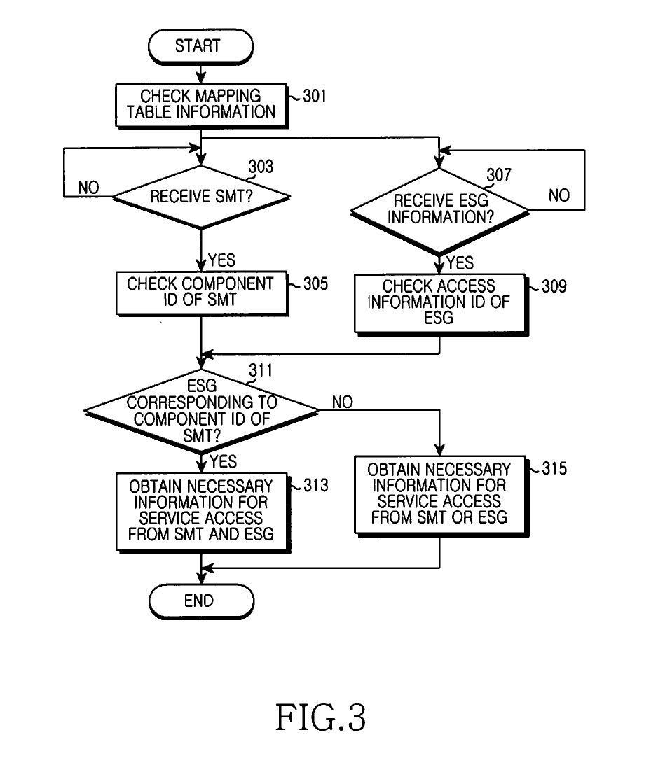

FIG. 3 is a flowchart illustrating the mobile station determining the service access information in the mobile broadcasting system according to an embodiment of the present invention.

In step 301, the mobile station determines a mapping table including the matching information of the ESG and the SMT. For example, the mobile station receives the mapping table information from the serving base station.

In step 303, the mobile station determines whether the SMT is received. For example, the mobile station receives the SMT over a Fast Information Channel (FIC) provided from the serving base station. Herein, the FIC includes service and ensemble information such as the number of ensembles in the corresponding RF channel, the ensemble ID, a number of services in each ensemble, and the service ID.

Upon receiving the SMT, the mobile station determines the component ID of the SMT in step 305. For example, the mobile station determines the component IDs for the respective program components of the SMT.

After determining the mapping table, the mobile station also determines whether the ESG is received in step 307.

When receiving the ESG, the mobile station determines the access information IDentification (ID) of the ESG in step 309. For example, the mobile station determines the access information ID for at least one access fragment in the ESG provided from the serving base station.

After determining the SMT component ID and the ESG access information ID, the mobile station determines whether the ESG matches the SMT, using the mapping table in step 311. For example, using the mapping table, the mobile station determines whether the ESG provided from the serving base station includes the access fragment having the access information ID matching to the component ID of the SMT.

Upon determining that the ESG matches the SMT, the mobile station recognizes the presence of the access fragment of the ESG including the same broadcasting service information as the program component of the SMT. Hence, the mobile station obtains necessary information for the service access by combining the matching SMT and ESG in step 313. For instance, the mobile station obtains the necessary information for the service access by combining the program component of the matching SMT and the access fragment of the ESG.

Upon determining that no ESG matches the SMT, the mobile station recognizes the absence of the access fragment of the ESG including the same broadcasting service information as the program component of the SMT. Thus, the mobile station obtains necessary information for the service access using either the SMT or the ESG in step 315.

The mobile station then ends this process.

Hereafter, a method of the serving base station for generating the component ID of the SMT by considering the access information ID of the ESG matching to the SMT is explained.

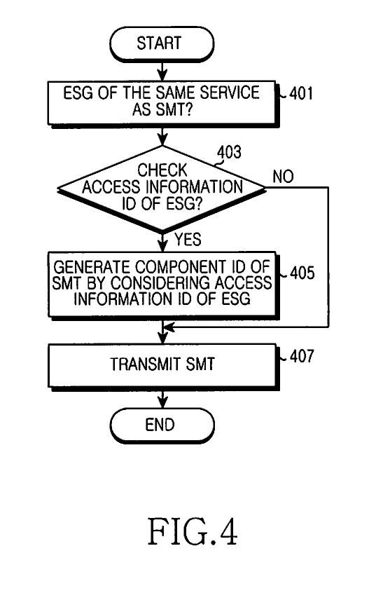

FIG. 4 is a flowchart illustrating a method for transmitting the service access information in the mobile broadcasting system according to another embodiment of the present invention.

In step 401, the serving base station determines whether the SMT and the ESG include the same service information. For example, the serving base station determines whether there exist an SMT program component and an ESG access fragment that include the same broadcasting service information.

Upon determining that no SMT and ESG have the same service information, the serving base station transmits the SMT to the service coverage area in step 407. For example, the serving base station constitutes the SMT including a certain component ID, as described in regards to Table 1. Although not illustrated in FIG. 4, it is recognized that the serving base station transmits the ESG for the broadcasting service over the service coverage area.

In contrast, when the SMT and the ESG have the same service information, the serving base station determines the access information ID of the ESG including the same service information as the program component of the SMT in step 403.

In step 405, the serving base station allocates the component ID for the program component of the SMT by taking account of the access information ID of the ESG including the same service information as the program component of the SMT.

After determining the component ID of the SMT, the serving base station transmits the SMT allocated the component ID in step 405, over the service coverage area in step 407. For instance, the serving base station constitutes the SMT including the allocated component ID as shown in Table 1 by taking into account the access information ID of the ESG. Although not shown in FIG. 4, it is recognized that the serving base station transmits the ESG for the broadcasting service over the service coverage area.

The serving base station then ends this process.

A method of the mobile station for determining the ESG matching to the SMT based on the component ID of the SMT is described below.

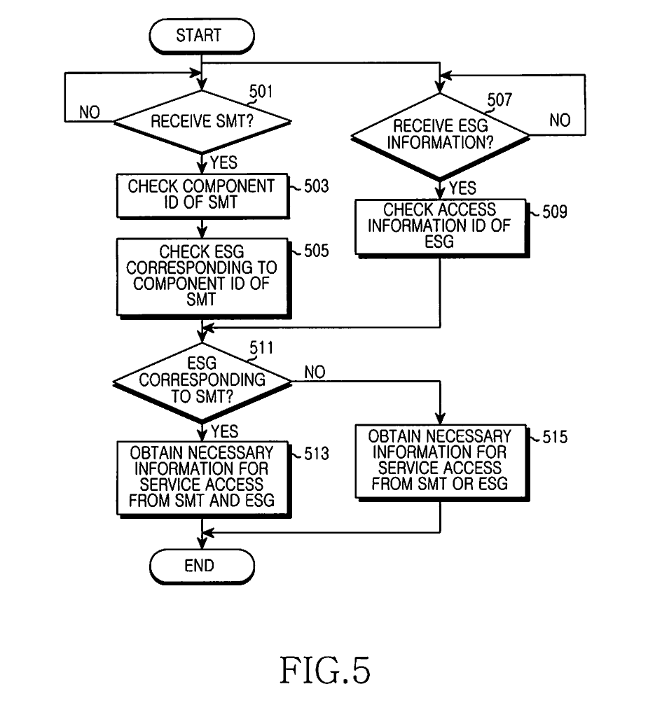

FIG. 5 is a flowchart illustrating the mobile station determining the service access information in the mobile broadcasting system according to another embodiment of the present invention.

In step 501, the mobile station determines whether the SMT is received from the serving base station. For example, the mobile station receives the SMT over the FIC provided from the serving base station. Herein, the FIC includes the service and ensemble information such as the number of ensembles in the corresponding RF channel, the ensemble ID, the number of services in each ensemble, and the service ID.

In step 507, the mobile station also determines whether the ESG is received from the serving base station.

When the SMT is determined to have been received in step 501, the mobile station determines the component ID of the SMT in step 503. For example, the mobile station determines the component ID for the at least one program component of the SMT.

In step 505, the mobile station determines the access information ID of the ESG matching to the program component of the SMT, based on the component ID of the SMT.

When the ESG is determined to have been received in step 507, the mobile station determines the access information ID of the ESG in step 509. For example, the mobile station determines the access information ID for at least one access fragment in the ESG provided from the serving base station.

In step 511, the mobile station determines whether the ESG provided from the serving base station includes the access fragment having the same access information ID as the access information ID of the ESG matching to the SMT.

Upon determining that the access fragment includes the access information ID matching to the SMT, the mobile station recognizes that the ESG and the SMT are matching. Hence, the mobile station obtains necessary information for the service access by combining the matching SMT and ESG in step 513. For instance, the mobile station obtains the necessary information for the service access by combining the program component of the matching SMT and the access fragment of the ESG.

Upon determining that the access fragment does not include the access information ID matching to the SMT, the mobile station recognizes the absence of the ESG matching to the SMT. Thus, the mobile station obtains necessary information for the service access using either the SMT or the ESG in step 515.

The mobile station then ends this process.

As set forth above, the component ID for matching the ESG and the SMT is added to the component ID of the SMT in the mobile broadcasting system, thereby reducing the overhead in matching the ESG and the SMT, and shortening a zapping time taken to access the service in the service play.

Although the present disclosure has been described with certain embodiments, various changes and modifications may be suggested to one skilled in the art. It is intended that the present disclosure encompass such changes and modifications as fall within the scope of the appended claims.

What is claimed is:

1. A method for determining broadcasting service information at mobile station of a mobile broadcasting system, the method comprising:
determining a mapping table which comprises matching information of a Service Map Table (SMT) and an Electronic Service Guide (ESG);
determining at least one component IDentifier (ID) in an SMT provided from a serving base station;
determining whether there is an ESG matching the at least one component ID of the SMT using the mapping table; and
when detecting that the ESG matches the component ID in the SMT, determining service information by combining the ESG that matches the SMT with the SMT.

2. The method of claim 1, wherein determining whether there is the ESG matching the at least one component ID further comprises:
determining an access information ID of at least one access fragment in an ESG provided from the serving base station;
determining an access information ID matches at least one component ID in the SMT, in the mapping table; and
determining whether at least one access fragment of the ESG includes an access fragment including an access information ID that matches the component ID in the SMT.

3. The method of claim 1, wherein determining the service information comprises:
combining a program component of the matching SMT and an access fragment of the ESG, and
determining the serving information using combined the program component and the access fragment.

4. The method of claim 1, wherein the mapping table includes matching information relating to program information of the SMT and an access fragment of the ESG, which includes information relating to a same broadcasting service.

5. The method of claim 1, further comprising:
when there is no ESG matching to the component ID in the SMT, determining the service information using either the SMT or the ESG.

6. An apparatus for determining broadcasting service information at mobile station of a mobile broadcasting system, the apparatus comprising:
a receiver for receiving a broadcasting signal; and
a controller for, when detecting an Electronic Service Guide (ESG) that matches a component ID of a Service Map Table (SMT) provided from a serving base station, based on a mapping table which includes matching information of the SMT and the ESG, determining service information by combining the ESG that matches the component ID of the SMT with the SMT.

7. The apparatus of claim 6, wherein the controller determines whether at least one access fragment of an ESG provided from the serving base station via the receiver comprises an access fragment including an access information ID that matches the component ID of the SMT determined in the mapping table.

8. The apparatus of claim 6, wherein the controller determines the service information by combining a program component of the matching SMT and an access fragment of the ESG.

9. The apparatus of claim 6, wherein the mapping table further includes matching information relating to program information of the SMT and an access fragment of the ESG, which include information relating to a same broadcasting service.

10. A method for transmitting broadcasting service information at base station of a mobile broadcasting system, the method comprising:
constituting a Service Map Table (SMT) and an Electronic Service Guide (ESG) which include information relating to a broadcasting service;
generating a mapping table which includes matching information of program components of the SMT and access fragments of the ESG, which include the same broadcasting service information; and
transmitting the SMT, the ESG, and the mapping table over a service coverage area.

11. The method of claim 10, wherein generating the mapping table comprises:
generating the mapping table which includes matching information of component IDs for program information of the SMT and access information IDs for the access fragments of the ESG, which include a same broadcasting service information.

12. A method for determining broadcasting service information at mobile station of a mobile broadcasting system, the method comprising:
determining at least one component IDentifier (ID) of a Service Map Table (SMT) provided from a serving base station;
determining an access information ID of an Electronic Service Guide (ESG) that matches a program component of the SMT, using the component ID;
determining whether an ESG matches the component ID of the SMT, using the access information ID of the ESG matching the program component of the SMT; and
when determining ESG matching to the component ID of the SMT, determining the broadcasting service information by combining the ESG that matches the SMT with the SMT.

13. The method of claim 12, wherein determining whether there is an ESG match comprises:
determining an access information ID of at least one access fragment in the ESG provided from the serving base station; and
determining whether the at least one access fragment includes an access fragment includes an access information ID that matches the component ID of the SMT.

14. The method of claim 12, wherein determining the broadcasting service information comprises:
combining a program component of the matching SMT and an access fragment of the ESG.

15. The method of claim 12, further comprising:
when no ESG matching to the component ID of the SMT is detected, determining the service information using either the SMT or the ESG.

16. An apparatus for determining broadcasting service information at a mobile station of a mobile broadcasting system, the apparatus comprising:
a receiver for receiving a broadcasting signal; and
a controller for determining an Electronic Service Guide (ESG) matching to a Service Map Table (SMT) using at least one component ID of the SMT provided from a serving base station via the receiver, wherein when detecting ESG matching to the component ID of the SMT, determining service information by combining the ESG that matches the component ID of the SMT with the SMT.

17. The apparatus of claim 16, wherein the controller determines an access information ID of the ESG matching to a program component of the SMT using at least one component ID of the SMT, an access information ID is determined of at least one access fragment in the ESG provided from the serving base station, and whether the at least one access fragment includes an access fragment including an access information ID that matches the component ID of the SMT.

18. The apparatus of claim 17, wherein the controller determines the service information by combining the program component of the matching SMT and the access fragment of the ESG.

19. A method for transmitting broadcasting service information at a base station of a mobile broadcasting system, the method comprising:
generating an Electronic Service Guide (ESG) which includes information relating to a broadcasting service;
determining whether a program component of a Service Map Table (SMT) is provided including a same broadcasting service information as an access fragment of the ESG;
when detecting the program component of the SMT including the same broadcasting service information as the access fragment of the ESG, generating an SMT by allocating a component ID of the program component using an access information ID of the access fragment of the ESG including the same broadcasting service information; and
transmitting the ESG and the SMT over a service coverage area.

20. The method of claim 19, further comprising:
when not detecting the program component of the SMT including the same broadcasting service information as the access fragment of the ESG, allocating a random component ID to the program component of the SMT.
